(19) United States
(12) Patent Application Publication
(10) Pub. No.: US 2005/0232688 A1
(43) Pub. Date: Oct. 20, 2005

(54) Toilet brush comprising a cleaning and/or disinfectant product dosing device

(76) Inventor: Maximo Gavira Montes, Cadiz (ES)

Correspondence Address: GAVIRA MONTES, MAXIMO, P.O. BOX 304, POLIGONO INDUSTRIAL CAMPAMENTO, M360 SAN ROGUE, LA LINEA, M300, ES

(21) Appl. No.: 10/517,488

(22) PCT Filed: May 30, 2003
(86) PCT No.: PCT/ES03/00260

§ 371 Date: Nov. 27, 2004

(30) Foreign Application Priority Data
Jun. 5, 2002 (ES) P 200201283

(51) Int. Cl. B43K 5/14; A46B 11/06; A47L 13/22

(52) U.S. Cl. 401/289

(57) ABSTRACT

The invention relates to a toilet brush having different forms which constitute effective toilet bowl cleaning and hygiene means through the application of a product that is contained inside a portion of the body of said brush, which is squeezed by the user. The aforementioned body is hollow and made from an elastic material. Moreover, each end of said body comprises an open section and each open section is protected with a cover, the outlet section also being sealed by means of a breakable membrane. The invention also comprises an arm having a stepped proximal end which can be screwed to the outlet of the body, thereby causing the membrane to break and connecting the inside of the body with an axial hole in the arm. The axial hole consists of sections having different diameters and runs the length of the arm as far as a head portion which is disposed at the distal end thereof, said head comprising sets of bristles for cleaning operations. An extra piece can be added to the head in order to provide same with an angular configuration that can be used to access normally-inaccessible, concealed areas.

### THE PURPOSE OF THE INVENTION

This invention refers to a toilet brush with a doser for cleaning products and/or disinfectants, and which offers essential characteristics of novelty and significant advantages over known resources used for the same purposes in the current state of the technique.

More specifically, the brush in the invention constitutes a device which can be used on any part of a toilet, including places normally inaccessible with traditional methods, for the dosed delivery of products guaranteeing the cleanliness and hygiene of the toilet. To this end, the brush in the invention is designed on the basis of two fundamental elements, namely an elastic body and an arm, designed to be connected together, in the factory or at the moment of use. The body provides a fillable housing for the product to be used, and the arm allows the area to be reached where it is to be applied, whether itself or with the use of an end appendage bent at an angle. The arm (and if applicable that appendage) has a lengthwise opening with sections of different diameters, along which the cleaning/hygienic product can move when the user manually applies the appropriate pressure on the elastic body.

The field of application of the invention falls obviously within the industrial sector dedicated to the manufacture of articles and auxiliary utensils with both domestic and industrial cleaning applications.

### BACKGROUND AND SUMMARY OF THE INVENTION

It is known that, over time, it has been possible to amend and enhance cleaning practices in application to such a basic element as, for example, the toilet in a home or in a facility of some other type.

In this sense, with a brief reference to the history and development of the methods used, it can be said that the introduction of water for the cleaning of this item meant a major advance since, until then, waste was simply taken out, or deposited in latrines or on sites prepared for the purposes.

However, use of water for cleaning purposes did not eliminate the unpleasant and unhealthy emanations, so it was necessary to try to reduce the odour, using a large amount of water, without achieving the desired result.

The use of valves associated with this type of element was able to considerably reduce the emission of unpleasant odours, though not to eliminate them completely. Water was seen to be the only effective block to bad odours, so that the appearance of the trap represented a significant advance, making it possible to avoid all types of odours and so resolve the problem.

Then, following the solution of the problem of odours, toilet cleaning was done with manual brushes. However, the toilet brushes currently on the market are made up simply of a rigid, compact handle and a top or head containing cleaning fibres. The cleaning is done by rubbing the toilet bowl with the bristles: however, these brushes all lack any form of feeder for the disinfecting product, or any other device to carry the product, so that the user, with a bottle or jar, from time to time stops to pour some drops or a stream on to the surface of the toilet bowl to be cleaned with the result that, in the intervals, pathogenic germs proliferate and develop, apart from the fact that perfect cleanliness is never possible, with the complete elimination of pathogenic micro-organisms.

The present invention has been proposed with the fundamental objective of providing a brush which overcomes the drawbacks in the current state of the technique. To do this, the brush in the invention has been developed with a body made of elastic material such as rubber or the like, and a rigid arm. The body is hollow, so as to provide a space in which to place a given quantity of a known product with cleaning and disinfection, germicidal and bactericidal characteristics, and with an access opening at one end, closed with a cap through which it can be filled when the product inside is finished: on the opposite end, there is a second opening blocked by a membrane, of the same material as the body or any other material, which can be perforated by the user at the moment of use by screwing on one end of the arm to that second opening in the body. The arm has a longitudinal opening through which the liquid flows from the elastic body toward the far end of the arm when the user presses lightly with the hand on the elastic body. Said far end of the arm carries a head with bristles, and the head may be straight, in line with the arm, or fitted with an inclined addition at an angle, with which to reach the most hidden parts of the toilet.

With a device of this type, the brush makes it possible to dose the amount of substance required at any time in a controlled way, depending on the dirtiness of the toilet to be cleaned, while the angular appendage means too that the necessary amount of disinfectant liquid can be applied in the most concealed and inaccessible corners, also by pressing manually on the elastic body. These operations are done “remotely”, i.e. the brush in the invention means the user does not to have to get too close to the dirt with the consequent hazard to health, and with the additional advantage that the hygiene and asepsis provided to the toilet protect the user permanently against possible infections, as well as keeping the area free of the emanation of bad odours.

The brush of the invention has been designed with ergonomic dimensions for manual use, and is also easy to handle, economical and long-lasting. The body can be held by anyone, and the materials used in its manufacture are stable, hygienic, of the various types currently on the market, while the disinfectant products are also of the type offered by the current industry. The detergent solutions used should, preferably, have maximum germicidal, bactericidal and disinfectant power.

A further advantage of the brush of the invention is that both the body and the arm, being made of separate and independent components can, should either of them be damaged or broken, be replaced by a spare of the same sort.

### A BRIEF DESCRIPTION OF THE DRAWINGS

These and other characteristics and advantages of the invention will become clearer with the detailed description following of a preferential design of the invention, given purely by way of illustration and without limitation, with reference to the accompanying drawings in which:

FIG. 1 shows diagrammatic elevation views of a longitudinal section and a finished brush in a first design of the invention, along with four details showing constructional characteristics of the brush;

FIG. 2 shows diagrammatic views similar to those in FIG. 1, in a second design of the invention;

FIG. 3 shows diagrammatic views similar to those in FIGS. 1 and 2, in a third design of the invention, and

FIG. 4 is a diagrammatic representation of two views, respectively in longitudinal cross-section and complete, of the end section of the arm in a design where said arm includes a head with an angular appendage.

### DESCRIPTION OF THE FORMS OF PREFERENTIAL DESIGNS

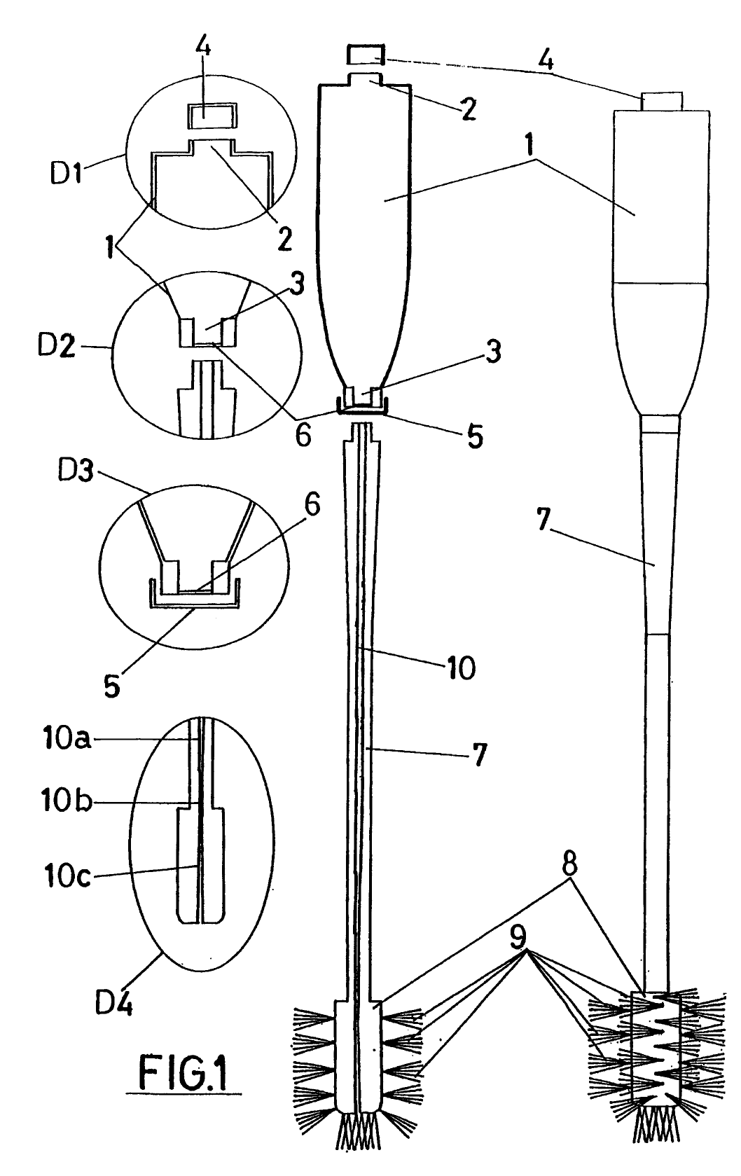

As indicated above, the detailed description of the forms of preferential design of the invention will refer to the attached drawings, in which the same numerical references are used to identify the same or similar parts. In this sense, from the representations in FIG. 1 in the first place, views are seen which are related to a first form of design of the toilet brush of the invention, in the straight-arm version ending in a coaxial head with the bristles for the cleaning operation.

In line with this figure, a brush according to the invention comprises a body 1 made of elastic material such as rubber or the like, and hollow in order to create an interior space to hold the hygienic and disinfectant products to be applied to the toilet bowl. The body 1 is ergonomic and so can easily be held in one hand by the user in order to press said body to project the product from the inside, as will be seen subsequently. In addition, the elasticity of the material it is made of allows the body 1 to recover its original form when the pressure of the user's hand ceases.

Said body 1 has an opening at each end, one of which 2 is the opening for filling or for access to the inside of the body, while opening 3 at the opposite end allows the product to emerge from the interior when projected under the appropriate pressure. Both openings are closed by caps 4 and 5 while opening 3 for the outlet has on its inside surface a suitable screw (not shown), and incidentally closed by a membrane 6.

The second element of the brush is an arm 7, generally elongated, with a first part generally in the form of an inverted cone, followed by a second part of cylindrical configuration. The first end of the arm, the proximal end, is designed with a stepped section with an external thread (not shown) complementing the thread of opening 3 of the body, while the other or distal end has a portion of head 8, of greater diameter, containing a multiplicity of groups of bristles 9 for cleaning operations.

Inside said arm 7 there is an opening 10 running from one end to the other, to carry the disinfectant product from its housing inside the body 1 to the outlet at the far end of the arm, to extend and apply it in a way which in itself is familiar, using the bristles 9. The view of the complete brush in this FIG. 1 shows how the groups of bristles are distributed completely around the head portion 8.

In addition, the lengthwise opening of the arm 7 is not of a uniform diameter: it has a number of sections with different diameters. This design, where the cross-section of the opening is reduced, produces a siphon effect preventing the liquid from dripping. Detail “D4” in this Figure has successive sections, 10a, 10b and 10c, with different diameters, of which the intermediate section, 10b, is a form of “bottleneck”, appreciably smaller than the other two. This design characteristic is maintained throughout the whole length of longitudinal opening 10, in order to achieve the effect referred to.

Otherwise, details “D1”, “D2” and “D3” are simply illustrations of features already referred to, shown at greater scale to facilitate their understanding, and referring in turn to the connection of the cap 4 to the part of the opening 2 on body 1, the position of the membrane 6 closing the outlet from opening 3 in body 1, and the protection of that membrane 6 by the use of a cap 5.

Preferentially, the form of presentation of the assembly would be broken down, i.e. body 1 separated from arm 7, so that the actual user assembles it at the moment of use. For this, it is sufficient to remove cap 5 from body 1, unscrewing it from the section of opening 3, and connecting the stepped area of the near end of arm 7 to that opening 3, by screwing and breaking the membrane 6. In this way, the inside of the body 1 is connected to opening 10 on the arm, and slight hand pressure is sufficient on said elastic body 1 to impel the liquid through opening 10 to the end of arm 7 outlet, at the head 8 with the cleaning bristles 9.

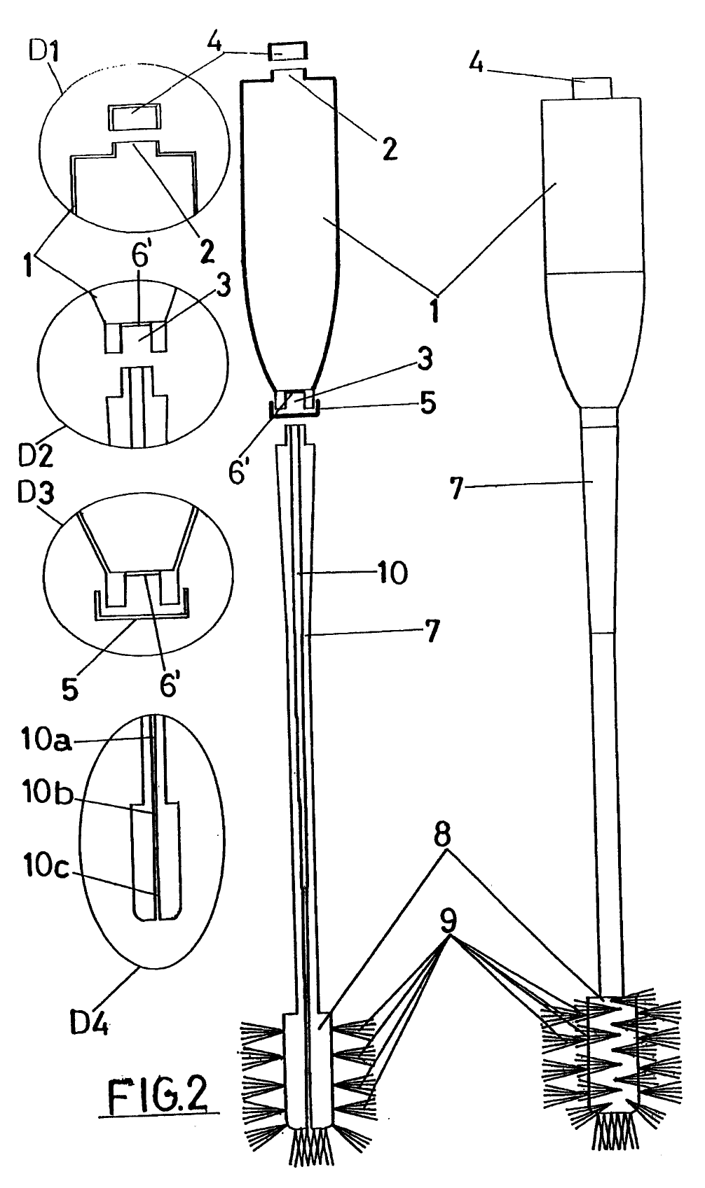

FIG. 2 shows a second design of the brush in the invention, whose characteristics are identical to those in the design in FIG. 1, except that the membrane 6′ closing opening 3 at the bottom of the body 1 is now placed inside the body, sealing the opening at its most internal point, made with the same material and integrated into said body 1. Detail D2 shows more clearly this position, and the protection of the membrane until the moment of use, also using a cap 5. Moreover, as in the case of the first design, the preferential form of presentation of the assembly is with both elements of the body and arm separated, coupling them when they are to be used and in such a way that the near stepped end of the arm 7 when screwed into opening 3 breaks and perforates the membrane 6′, so connecting the inside of body 1 with the outlet opening 10.

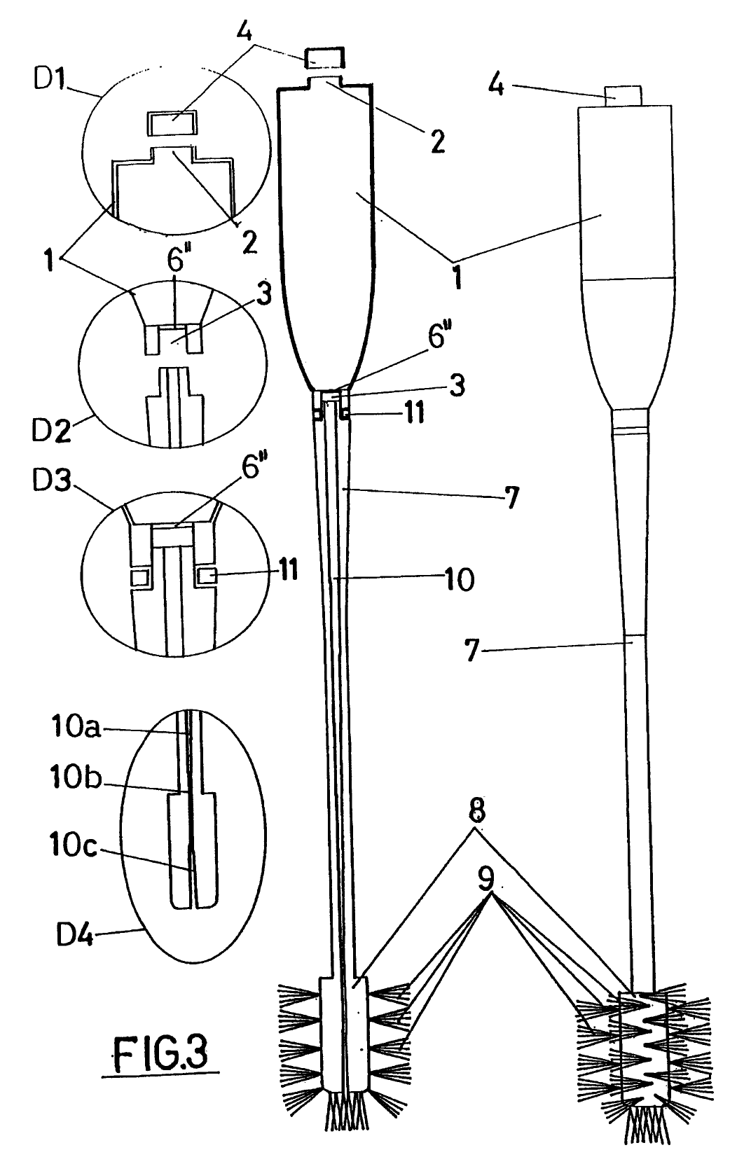

For its part, FIG. 3 is a third alternative design of a toilet brush formed by the same body and arm elements but which, preferentially, is supplied to the user in assembled form. However, to prevent the space inside the body 1 from connecting with the outlet opening 10 before use, possibly allowing the product inside the body to leak, the near stepped end of the arm 7 is placed away from the membrane 6′ and does not perforate it thanks to an intermediate ring 11 which acts as a stop between the two components, preventing the membrane from coming within the reach of the arm end. When the assembly is to be used, all that is required is to remove the ring 11 by gentle manual traction, and to screw arm 7 completely into the body 1 to break said membrane 6′, in order to use the brush in the manner already described.

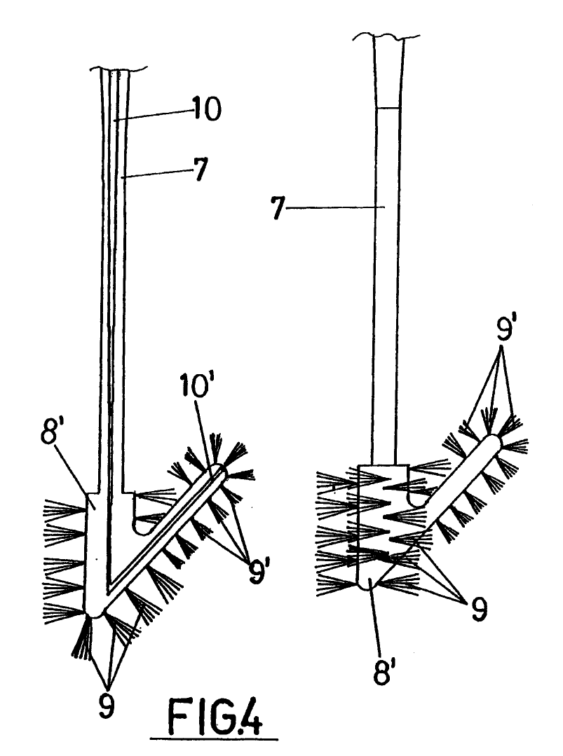

Finally, with reference to FIG. 4, a diagrammatic representation is shown, in cross-section and finished view, of an end head 8′ usable in any of the designs of the invention, configured with an angular appendage turned back to form an acute angle with the axis of the arm 7. It is a feature of said appendage that, on the one hand, it also has an axial internal opening 10′ throughout its length, connecting with and continuing the opening 10 in arm 7 and, on the other, it has a multiplicity of groups of bristles 9′ distributed over the outside surface. This arrangement allows the user, holding the assembly by body 1, to apply cleaning, hygienic and disinfectant product to any concealed corner which, otherwise, could not be accessed, thereby guaranteeing that the whole toilet bowl is kept in the best possible hygienic conditions.

It will be seen that the brush of the invention is a simple, economical and versatile means in comparison with those known and used according to the present state of the technique, providing an effective solution to existing problems of cleaning, hygiene and disinfection.

It is also easily understood that the body 1 can be filled once the product inside is finished. This requires no more than the removal of the cap 4 closing the opening 2 on the body and, following replacement of the finished products inside the body, to refit it, once more closing said access opening 2.

It is not felt necessary to extend this description further in order for any expert in the field to grasp the scope of the invention and its benefits and to develop and implement the subject hereof.

It must however be understood that the invention is described according to a preferential design, so may be modified provided that this does not involve any alteration to the fundamentals of said invention: such alterations may, in particular, affect the shape, size and/or the materials of which the assembly or its components are made, an the different types of liquid products which can be used with the brush of the invention.

1. A toilet brush with a doser device for cleaning and/or disinfecting products, intended for use in operations for the cleaning, hygiene and disinfection of the toilet bowl, allowing the user to dose and control the application of a hygienic and disinfecting liquid product, wherein there are two fundamental elements, namely an elastic body (1) and a rigid body (7), in which:
the body (1) is ergonomically designed, easily taken by the user in the hand, and hollow inside to provide a housing for the hygienic and disinfecting product to be applied to the toilet bowl using the brush and, at one end, with an opening portion (2) closed by means of a cap (4) threaded onto its outside, for entry or access to the inside of the body in order to refill the product once it is finished, and an opening portion (3) at the opposite end, with a thread outside and inside, which is the outlet for the product from the internal container space, and closed off by a cap (5) threaded onto its outside,
the arm (7) is generally elongated and with its proximal end in stepped form and with an outside thread complementing the inside thread of the opening (3) on body (1), while the distal end has a head portion (8) of greater diameter to which a multiplicity of groups of bristles (9) is fixed for cleaning, distributed over its outside surface, said arm (7) having an axial opening (10) running right along its length between both proximal and distal ends.

2. A toilet brush as set forth in claim 1, wherein the opening portion (3) of the outlet from the body (1) incorporates a membrane (6, 6′) which can be applied to the external or the internal part of said portion (3) of the outlet opening, keeping this opening closed until it is perforated by the proximal stepped end of the arm (7) as it is screwed onto said opening.

3. A toilet brush as set forth in claim 1, wherein the axial opening (10) of the arm (7) varies in diameter so as to create a bottleneck section with a siphon effect to prevent unwanted dripping of product.

4. A toilet brush as set forth in one or more of the previous claims, wherein an alternative design features a brush with an intermediate ring (11) at the connection between the proximal end of arm (7) and the opening portion (3) of body (1), serving as a stop between the two elements and preventing the membrane (6′) from coming within the reach of said arm and being perforated by it until said intermediate ring (11) has been completely removed.

5. A toilet brush as set forth in one or more of the previous claims, wherein the head portion associated with the distal end of the arm (7) may be of an angular configuration with an appendage turned backward to form an angle with the longitudinal axis of the arm (7), said appendage having an axial open portion (10′) connected to the opening (10) in the arm, as well as several groups of bristles (9′) for access to and cleaning of corners and other positions normally inaccessible.
